(19) United States
(12) Patent Application Publication
(10) Pub. No.: US 2021/0272237 A1
(43) Pub. Date: Sep. 2, 2021

(54) MULTIMODAL CT IMAGE SUPER-RESOLUTION VIA TRANSFER GENERATIVE ADVERSARIAL NETWORK

(71) Applicant: University of Florida Research Foundation, Inc., Gainesville, FL (US)

(72) Inventors: Ruogu FANG, Gainesville, FL (US); Yao XIAO, Gainesville, FL (US)

(21) Appl. No.: 17/186,471

(22) Filed: Feb. 26, 2021

Related U.S. Application Data
(60) Provisional application No. 62/983,660, filed on Feb. 29, 2020.

(51) Int. Cl. G06T 3/40; G06N 20/00; G06T 7/00

(52) U.S. Cl. CPC G06T 3/4053; G06N 20/00; G06T 2207/20081; G06T 2207/10081; G06T 7/0012

(57) ABSTRACT

Various examples related to CT imaging using multimodal CT image super-resolution are provided. In one example, a method includes generating an enhanced super-resolution generative adversarial network (ESRGAN) by training a generative adversarial network (GAN) with a plurality of CT image modalities (e.g., non-contrast CT, CT Perfusion, CT Angiography, CT with contrast-enhanced, etc.) and generating an enhanced CT image by applying the ESRGAN to a low resolution CT image. In another example, a system includes at least one computing device and program instructions stored in memory and executable in the at least one computing device that, when executed, cause the at least one computing device to generate an ESRGAN by training a GAN with a plurality of CT image modalities and generate an enhanced CT image by applying the ESRGAN to a low resolution CT image.

### CROSS REFERENCE TO RELATED APPLICATIONS

This application claims priority to, and the benefit of, co-pending U.S. provisional application entitled “Multimodal CT Image Super-Resolution via Transfer Generative Adversarial Network” having Ser. No. 62/983,660, filed Feb. 29, 2020, which is hereby incorporated by reference in its entirety.

### STATEMENT REGARDING FEDERALLY SPONSORED RESEARCH OR DEVELOPMENT

This invention was made with government support under Grant Nos. 1758430 and 1908299 awarded by the National Science Foundation. The Government has certain rights in the invention.

### BACKGROUND

Acute stroke is the second leading cause of death and severe long-term disability worldwide. Around 15 million people have a stroke each year, and 10 million people die or permanently disabled. For diagnosis and therapeutic planning purposes, these patients of stroke suspected usually need to undergo multimodal computed tomography (MMCT) scanning including non-contrast CT (NCCT), CT Perfusion (CTP), CT Angiography (CTA), and CT with contrast-enhanced (CTWC). With the high dose scan characteristics, the NCCT scan provides radiologists comprehensive brain anatomical structure details and a general identification of the stroke type: hemorrhagic or ischemic. The CTP scan provides substantial information about hemodynamics of the brain parenchyma, which usually conducted by prolong-repeated CT scans with contrast dose injection. The CTA scan provides better visualizations on the vasculature system, which helps the detection of vessel occlusion or other vessel abnormalities. The CTWC scan shows the slowing filling arteries or veins, which provides additional information of the disease.

In order to achieve a better image visualization to assist in stroke diagnosis and treatment planning, high radiation exposure is utilized. The accumulated radiation exposure increases the health risks such as cataract formation and cancer induction. Image quality of MMCT also varies from series to series due to different acquisition settings. As radiation exposure can be adjusted by tuning the CT scanning parameters like pitch, slice thickness, X-Ray beam filter type, and other parameters, the image quality toward low-dose purpose becomes poor. There is a need to develop an approach to improve the MMCT image quality for better visualization and to reduce radiation exposure “as low as reasonably achievable.”

### SUMMARY

Aspects of the present disclosure are related to improvements in CT imaging using multimodal CT image super-resolution. An enhanced super-resolution generative adversarial network (ESRGAN) trained with a plurality of CT image modalities can be used to generate enhanced CT images from low resolution CT images.

In one aspect, among others, a method for multimodal computed tomography (CT) image super-resolution comprises: generating an enhanced super-resolution generative adversarial network (ESRGAN) by training a generative adversarial network (GAN) with a plurality of CT image modalities; and generating an enhanced CT image by applying the ESRGAN to a low resolution CT image. In one or more aspects, the training of the GAN can comprise training the GAN with a first CT image modality; and training the GAN with a second CT image modality, wherein the GAN includes learning from the training with the first CT image modality. The first CT image modality can be non-contrast CT (NCCT) and the second CT image modality can be CT Perfusion (CTP).

In various aspects, the training of the GAN can further comprise training the GAN with a third CT image modality, wherein the GAN includes learning from the training with the first and second CT image modalities. The third CT image modality can be CT Angiography (CTA). The plurality of CT image modalities can be selected from the group consisting of non-contrast CT (NCCT), CT Perfusion (CTP), CT Angiography (CTA), and CT with contrast-enhanced (CTWC). The ESRGAN can comprise a plurality of residual in residual dense blocks (RRDBs) in series. Each of the plurality of RRDBs can comprise a convolution (Cony) layer and a leaky rectified linear unit (LReLU). The low resolution CT image can be obtained from a low dose CT scan.

In another aspect, a system for multimodal computed tomography (CT) image super-resolution comprises: at least one computing device; and program instructions stored in memory and executable in the at least one computing device that, when executed, cause the at least one computing device to: generate an enhanced super-resolution generative adversarial network (ESRGAN) by training a generative adversarial network (GAN) with a plurality of CT image modalities; and generate an enhanced CT image by applying the ESRGAN to a low resolution CT image. In one or more aspects, the training of the GAN can comprise training the GAN with a first CT image modality; and training the GAN with a second CT image modality, wherein the GAN includes learning from the training with the first CT image modality. The first CT image modality can be non-contrast CT (NCCT) and the second CT image modality can be CT Perfusion (CTP).

In various aspects, the training of the GAN further can comprise training the GAN with a third CT image modality, wherein the GAN includes learning from the training with the first and second CT image modalities. The third CT image modality can be CT Angiography (CTA). The training of the GAN further can comprise training the GAN with a fourth CT image modality, wherein the GAN includes learning from the training with the first, second and third CT image modalities. The first, second, third and fourth CT image modalities can comprise non-contrast CT (NCCT), CT Perfusion (CTP), CT Angiography (CTA), and CT with contrast-enhanced (CTWC). In some aspects, the plurality of CT image modalities can be selected from the group consisting of non-contrast CT (NCCT), CT Perfusion (CTP), CT Angiography (CTA), and CT with contrast-enhanced (CTWC). The ESRGAN can comprise a plurality of residual in residual dense blocks (RRDBs) in series. Each of the plurality of RRDBs can comprise a convolution (Cony) layer and a leaky rectified linear unit (LReLU). The low resolution CT image can be obtained from a low dose CT scan.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a table illustrating multimodal CT image acquisition parameters, in accordance with various embodiments of the present disclosure.

FIG. 2A illustrates an example of a Transfer-GAN framework, in accordance with various embodiments of the present disclosure.

FIG. 2B illustrates an example of an architecture for ESRGAN (enhanced super-resolution generative adversarial network), in accordance with various embodiments of the present disclosure.

FIG. 2C illustrates an example of a structure for Residual in Residual Dense Block (RRDB), in accordance with various embodiments of the present disclosure.

FIGS. 3A and 3B illustrate a comparison of (a) NCCT images, (b) CTP images, and (c) CTA images, in accordance with various embodiments of the present disclosure.

FIG. 4 illustrates a prefusion map comparison between the different methods (LR, Scratch, LT-GAN and GT), in accordance with various embodiments of the present disclosure.

FIG. 5 illustrates an example of computer architecture for performing the computer-implemented method for the multimodal CT image super-resolution, in accordance with various embodiments of the present disclosure.

### DETAILED DESCRIPTION

Disclosed herein are various examples related to improvements in CT imaging using multimodal CT image super-resolution. Reference will now be made in detail to the description of the embodiments as illustrated in the drawings, wherein like reference numbers indicate like parts throughout the several views.

Deep learning approaches, especially the generative adversarial network (GAN) structure, can be exploited in both natural and medical image quality enhancement. As image super-resolution (SR) is an ill-posed inverse problem, how to preserve the visual geometry such as edge information and shape details of the image structures are still an open question. With the hypothesis that structural features are highly correlated for the same patient in different CT scans, sharing and integrating the complementary information cross series by using transfer learning can be beneficial for high-resolution (HR) MMCT image generation. In this disclosure, extensive analysis is provided to demonstrate and evaluate the effectiveness of the proposed deep learning-based method Transfer-GAN on MMCT image quality enhancement.

Study Population and CT Image Acquisition

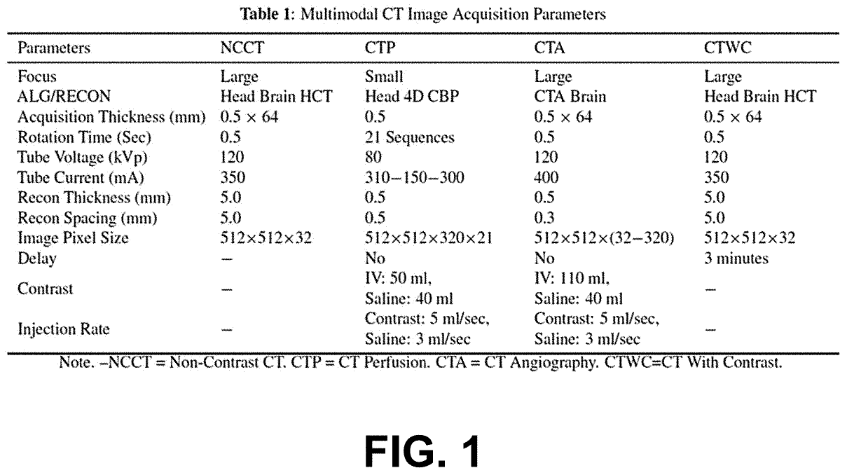

This retrospective study was with human study IRB approval and HIPAA compliance. The inclusion criteria were presence of cerebrovascular diseases and the availability of multimodal CT (NCCT, CTP, CTA, and CTWC) images obtained from the same imaging protocol between January 2013 and December 2018. Patients under 18 years old or pregnant were excluded. In total, 35 patients were collected. Multimodal CT images were acquired with the Aquilion One Canon Medical System, a 320-detector row scanner, where the detail acquisition parameters for each modality are different, which are tabulated in the table in FIG. 1. The CT images were reconstructed with Adaptive Iterative Dose Reduction with three-dimensional processing, AIDR 3D, standard setting; Canon Medical System.

Data Preprocessing

The number of images acquired from the multimodal CT scans were different for the individuals. Based on the acquisition protocol listed in the table in FIG. 1, NCCT and CTWC provided 32 axial images for each patient, CTP provided 6,720 axial images, and CTA provided from 32 to 320 axial images depending on the scanning settings for individuals. To better visualize the CT image, all the images were adjusted to brain windows based on Hounsfield Unit (HU) scale, which are 0-90 HU for NCCT, 0-200 HU for CTP images, 0-120 for CTA images, and 0-125 for CTWC images. Background and the skull were removed from all the images, and only the center brain regions with 10 slices were selected for analysis. The patients were randomly divided into a training set, a validation set, and a test set. Slices from the test set were selected (e.g., by a board-certified neuroradiologist) with lesion brain structures that can be used in acute stroke diagnosis. Using, e.g., the MATLAB bicubic kernel function, the LR images were down-sampled on the spatial dimensions into a quarter of the original size.

Transfer-GAN Model Design

Generative adversarial network (GAN) achieves realistic textures generation in both natural and medical single image SR, providing us an opportunity to reconstruct HR CT images. In this work, we aim to address multimodal CT image SR and demonstrate the feasibility of our GAN based transfer learning in integrating the shared and complementary information from different modalities to achieve high diagnostic image quality.

Transfer-GAN, a learning-based method using GAN with transfer learning is utilized to produce realistic multimodal CT images that can achieve high diagnostic image quality. With the hypothesis that multimodal images from the same patient are highly correlated in structural features, transferring and integrating the shared and complementary information from different modalities can be beneficial for high-resolution multimodal CT image generation. For instance, NCCT, the static anatomical brain imaging modality at a high spatial resolution, can contribute towards the restoration of CTP, a spatial-temporal dynamic imaging modality to capture both the anatomical structure at lower resolutions and blood flow dynamics (a.k.a. the functionality of the brain) over time. As for CTA images that require better vasculature visualization, CTP images at peak perfusion time can provide detailed information about blood flows, which can be useful for enhancing CTA image quality.

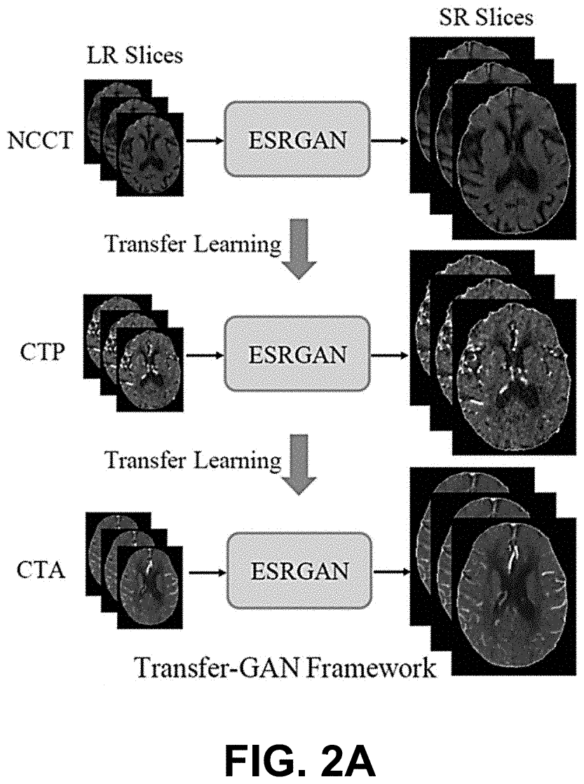

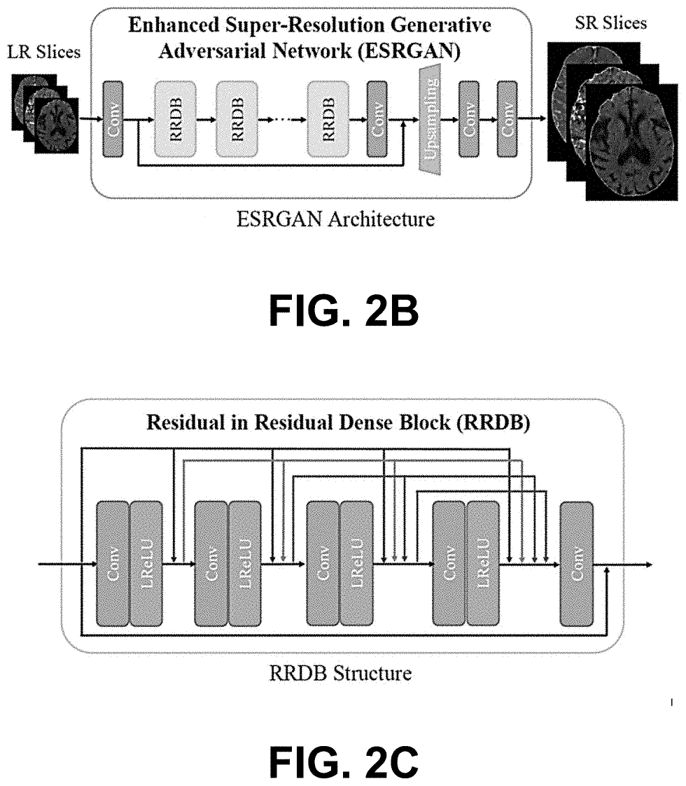

Referring to FIG. 2A, show is an example of the overall design of the Transfer-GAN framework. FIG. 2B shows the Enhanced Super-Resolution GAN (ESRGAN), which can achieve state-of-the-art performance in natural image SR. The Transfer-GAN framework utilizes the application of GAN in the medical imaging domain. The ESRGAN architecture of the Transfer-GAN framework comprises three parts, a generator, a discriminator, and a loss calculator. The aim of the generator of the proposed GAN structure is to synthesize HR images that are similar to the ground truth HR images. A Residual in Residual Dense Block (RRDB) can be utilized as a basic building unit in the GAN generator, as more layers and the denser of the connections will boost the performance.

FIG. 2C illustrates the structure of the RRDB. This dense block contains a convolution (Cony) layer and leaky ReLU (LReLU). The RRDB of FIG. 2C comprises 4 pairs of Conv-LReLU layers and a convolution layer at the end. Each Conv-LReLU pair can include one filter sized of 3×3 Cony layer and followed by one LReLU layer. When x<0, the leaky ReLU will retain a negative mall slope instead of making the function into zero in the ReLU. In the experiments, 23 RRDB blocks were concatenated.

A relativistic discriminator can be used to predict the probability of a real image to determine whether it is relatively more realistic than a fake image. A VGG network can be applied as the relativistic discriminator. The perceptual loss can be calculated by constraining features before activation rather than after activation. Based on the perceptual similarity idea, the perceptual loss can be defined as the minimized distance between two activated features. However, there are two drawbacks to conventional perceptual loss. The activated features become sparse when the network becomes deeper, which will provide weak activation and lead to inferior performance. Another drawback is that the features after activation may cause inconsistent reconstruction brightness compared to the ground truth image. Therefore, using the features before activation layers is more convincing.

Experimental Settings

Experiments were conducted utilizing a GPU workstation which contained four NVIDIA PASCAL xp GPUs. The batch size was set to 16, and the spatial size of the HR patch to 128 in model training as a larger receptive field is helpful in capturing the semantic details. The stopping criteria was based on the training iterations 20,000 iterations for all modalities.

As illustrated in FIG. 2A, the NCCT, CTP, and CTA images are first trained, respectively, with initial weight distributions as the baseline models. Then, the training on the other modalities is continued by finetuning the baseline models. More specifically, following the scanning sequence in acute stroke protocol, the TL-CTP model is trained with NCCT images, then fine-tuned on the CTP images. For the TL-CTA model, the CTP model is further fine-tuned with CTA images; thus, the knowledge learned from the previous modality can be utilized in the following modality image reconstruction. As the NCCT is the first scanning modality, the TL-NCCT is trained with natural images (e.g., a DIV2K dataset) first, then fine-tuned on the NCCT images. In some embodiments, four (or more) CT modalities can be used for the training.

Quantitative Analysis (Evaluation Metrics)

The quantitative image quality can be evaluated by, e.g., three metrics: relative root-mean-square-error (RMSE), peak-signal-to-noise-ratio (PSNR), and structural-similarity index (SSIM). RMSE measures the differences between an image and the ground truth image. PSNR measures the reconstruction quality of an image. SSIM measures the similarity between an image and the ground truth image.

Qualitative Analysis (Visual Grading/Assessment Criteria)

Reviewers were asked to rate the images for the selected lesion slices based on the diagnostic region of interests. The images for reviewing include the LR images that were reconstructed by bicubic interpolation, the generated images from baseline methods, the generated images from TL-GAN, and the original HR images. The images were assigned a random series number and order such that the reviewers had no information about the labels or ordering, and all overlay information was identical for all the series. The reviewers were using DICOM-calibrated radiologist reading monitors, and the reviewers were free to use all tool typically used for interpretation (window and level, zoom, and viewer windows). Reviewers independently rated the overall quality of images on a Likert scale (1=very unclear or not confident, 2=unclear or less confident, 3=neutral, 4=clear or more confident, and 5=very clear or very confident) based on image quality and the confidence of making the diagnostic decision. The scores were given according to the specified visual sharpness criteria including 1) the contrast between white and gray matter, 2) the basal ganglia, 3) the ventricular system, 4) the cerebrospinal fluid space around the mesencephalon, 5) the cerebrospinal fluid space over the brain, and 6) the great vessels and the choroid plexuses after intravenous contrast media. In addition to scoring each series on a Likert scale, reviewers also indicated a preferred series or no preference based on the overall image quality.

Statistical Analysis

All statistical analyses in this disclosure were performed one-tailed paired t-test with α=0.05, which indicated whether the quality of the generated images was significantly better than the ground truth images or the generated images from a different method. The statistical analysis results were reported for both visual comparisons and quantity comparisons of multimodal CT images and the generated perfusion maps.

### Experimental Results

The patient population for experimental testing in this disclosure included thirty-five patients with multimodal cerebral CT scans. These patients were randomly split into three sets for model training, validation, and testing. The patients were randomly split into a training set (e.g., 4 patients), a validation set (e.g., 2 patients), and a testing set (e.g., 3 patients).

Baseline Study by Generative Adversarial Network

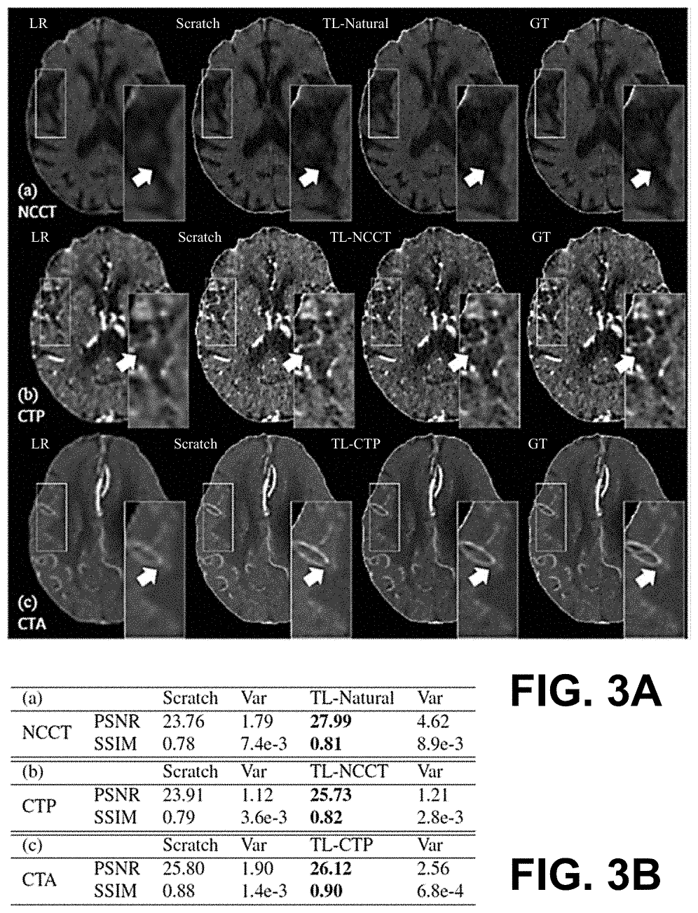

By using the GAN models, image quality of all LR images from different CT modalities had been improved, which was comparable to the original HR images. The visual comparison of the different CT modalities can be seen in FIG. 3A, which shows (a) NCCT images, (b) CTP images, and (c) CTA images reconstructed by different methods. The methods can include the low-resolution image from bicubic interpolation (LR); no pretraining and training from random initialization (Scratch); transfer learning from natural images (TL-Natural); transfer learning from non-contrast CT images (TL-NCCT); transfer learning from CTP images (TL-CTP); and the original high-resolution image (GT).

For NCCT image SR, the areas between the two white arrows in the enlarged region, the boundary of CSF and the gray matter were clearly shown, which provided more details than the HR image. Similarly, for the resulting CTP images, the boundaries of the blood vessels, as the white arrow points out, were much sharper compared to the bicubic method. One-tailed paired t-tests were performed with α=0.05 to compare the performance improvements of PSNR and SSIM for the multimodal CT images. Through the baseline models, there is a significant improvement (p<0.05) for both PSNR and SSIM for transferred from NCCT to CTP images than directly training for CTP images, and there is a significant improvement for CTA images by transfer learning from CTP images.

Transfer Learning Improves Performance

The model performance was evaluated by both visual and quantitative (PSNR and SSIM) comparisons. As shown in FIG. 3A and the table in FIG. 3B, the performance after using transfer learning had significantly improved from the baseline models. Quantity comparisons of (a) NCCT, (b) CTP, and (c) CTA images reconstructed by different methods. (Scratch: Training from random initialization. TL-Natural: Transfer learning from natural images. TL-NCCT: Transfer learning from NCCT images. TL-CTP: Transfer learning from CTP images.) The quantity comparison is shown in the table in FIG. 3B, which was calculated as an average result from 184 NCCT, 882 CTP, and 107 CTA test images. The best performance is highlighted in bold font.

As previously indicated, one-tailed paired t-tests were performed with α=0.05 to compare the performance improvements of PSNR and SSIM for the multimodal CT images. Through transfer learning of GAN, there is a significant improvement (p<0.05) for both PSNR and SSIM for transferred from NCCT to CTP images than directly training for CTP images, and there is a significant improvement for CTA images by transfer learning from CTP images.

In the visual comparisons shown in FIG. 3A. the region of interests were enlarged and are displayed on the side. As pointed by the white arrows, it can be seen that the pointed area is better in transfer learning than the learning from scratch and LR with bicubic interpolation. The details can be reconstructed clearly with higher contrast, and the edges are preserved much better.

Therefore, the experimental results provide support that transferring and integrating the shared and complementary information from different modalities is practical for high-resolution multimodal CT image generation.

Perfusion Map Analysis

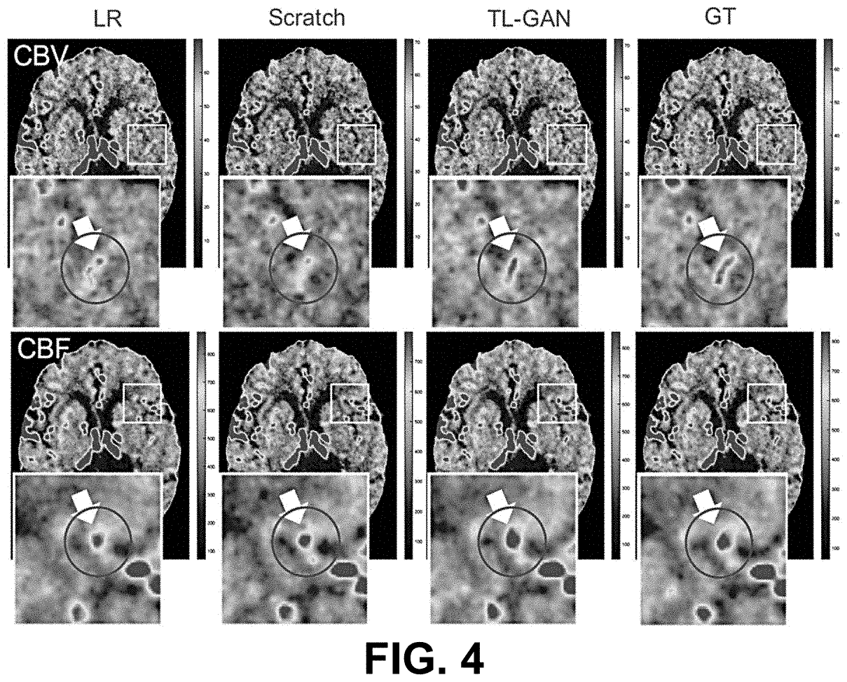

Hemodynamics analysis was also provided for the CTP scans. Referring to FIG. 4, shown are examples of perfusion maps regarding CBF and CBV for the visual comparison with using transfer learning and without using transfer learning. As shown in the enlarge regions indicated with white arrows pointed, deep learning methods can preserve the details in the perfusion maps, which are comparable to the original maps calculated from the HR scans.

Effect of Training Data Size on Super-Resolution Performance

An experiment was also designed for analysis of the effect of training data size on the SR performance. The experiment used different amounts of NCCT images for training, e.g., starting with 100 images with 100 image increments until reaching 1000 images. The performance was increased when the training images reached a threshold amount. For transfer learning, there is not a big difference by using a large training set when compared to transfer learning from only a few images.

Summary of Results

In this disclosure, Transfer-GAN, an end-to-end multi-modal image super-resolution network with the transfer learning strategy, was proposed and examined. The experimental results indicate that the approach can improve NCCT image quality by learning from the natural images, can improve CTP image quality by learning from NCCT images, and can improve CTA image quality by learning from CTP images, thus, provides a practical solution for multimodal CT image quality enhancement. Thus providing, for the first-time, an integration of transfer learning and GAN for multimodal CT image super-resolution. With the shared and complementary information in NCCT, CTP, and CTA images, integrating the features from different scans are beneficial to achieve high diagnostic imaging quality, which provides a novel solution for image quality enhancement in multimodal CT imaging instead of single modality for the general population. Transfer-GAN also offers a solution for maintaining high image quality in support of radiation dose optimization in multimodal CT scanning, providing a safer multimodal CT scan strategy for comprehensive brain imaging.

The clinical usage and significance were also considered. Based on the combined reviewer assessment results, the Likert preference indicated a significant image quality improvement from the LR images for image quality criterion. The reviewers were confident in making the diagnostic decisions with the resulting images from the Transfer-GAN model, which indicated the image quality were comparable to the ground truth images.

As shown in this disclosure, transfer learning and GAN can be an effective approach for multimodal CT image SR. The basic models were trained using images from a group of patients, which provides a small dataset. The time and effort to train the entire models for different CT modalities were efficient and low cost by using transfer learning with a relatively small amount of additional training data (100 images for each modality). This suggests that the amount of training data for a particular task does not necessarily increase linearly with the number of modalities or image contrasts. The basic model results demonstrated that even though a small dataset was used, the reconstructed image quality was comparable to the ground truth images that are considered to be the state-of-the-art method. After applying the transfer learning, the basic model was further improved with the prior knowledge from the different CT modalities. The performance showed that there was a significant improvement from transfer learning with natural images. It demonstrated that the image details learned from CT images are beneficial for CT image quality enhancement, and the quality are comparable to the ground truth images which can be used in stroke diagnosis.

As image quality are highly correlated to the radiation dose, the low quality CT images from the low dose scans can be reconstructed to generate high quality images. Transfer-GAN provides a solution in reconstructing HR images from low-dose scans. In addition, the experiments here were using images at a quarter size compare to the ground truth images as inputs, and the reconstructed images were the same size as the ground truth images. Therefore, providing a way to reduce the storage size for CT scans.

Since low dose multimodal CT scans were not collected due to patient protection policy, only simulated LR images were considered from a MATLAB bicubic kernel function. Other deep learning structures were not provided for performance comparisons and experiments regarding different radiation dose levels and image noise levels were not provided. The patient data was limited as well.

The illustrations of FIGS. 2A-2C show the architecture, functionality, and operation of a possible implementation of the Transfer-GAN framework software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 2A-2C. For example, two blocks shown in succession in FIGS. 2A-2C may in fact be executed substantially concurrently or the blocks may sometimes be executed in the reverse order, depending upon the functionality involved, as will be further clarified hereinbelow.

Any process descriptions or blocks in FIGS. 2A-2C can be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

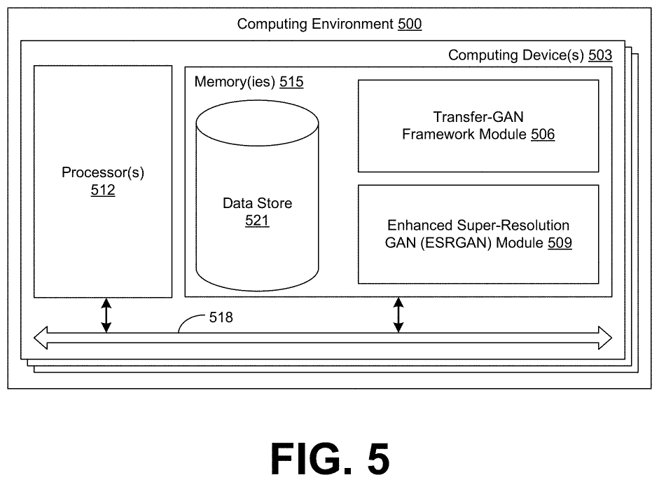

Turning now to FIG. 5, an example computing architecture is described that includes a computing environment 500 having one or more computing devices 503. To perform the multimodal CT image super-resolution described herein, the computing devices 503 can include a Transfer-GAN framework module 506, an ESRGAN module 509, as well as other services, applications, or modules. The computing devices 503 that implement the networks, the routines, or other computer-implemented methods or algorithms described herein can include at least one processor circuit, for example, having a processor 512 and at least one memory device 515, both of which can be coupled to a local interface 518, respectively. The computing device 503 can include, for example, at least one computer, a mobile device, smartphone, personal computer, server, or like device. The local interface 518 can include, for example, a data bus with an accompanying address/control bus or other bus structure.

Stored in the memory device 515 are both data and several components that are executable by the processor 512. In particular, stored in the one or more memory devices 515 and executable by the device processor 512 can include a client application and potentially other applications. Also stored in the memory can be a data store 521 and other data. The data store 521 can include image training sets utilized by the Transfer-GAN module framework module 506, for example, as well as low resolution and high resolution CT images.

A number of software components are stored in the memory 515 and executable by a processor 512. In this respect, the term “executable” means a program file that is in a form that can ultimately be run by the processor 512. Examples of executable programs can be, for example, a compiled program that can be translated into machine code in a format that can be loaded into a random access portion of one or more of the memory devices 515 and run by the processor 512, code that can be expressed in a format such as object code that is capable of being loaded into a random access portion of the one or more memory devices 515 and executed by the processor 512, or code that can be interpreted by another executable program to generate instructions in a random access portion of the memory devices 515 to be executed by the processor 512. An executable program can be stored in any portion or component of the memory devices 515 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although various systems described herein can be embodied in software or code executed by general-purpose hardware as discussed above, as an alternative the same can also be embodied in dedicated hardware or a combination of software/general-purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagram and flowcharts show an example of the functionality and operation of an implementation of portions of components described herein. If embodied in software, each block can represent a module, segment, or portion of code that can include instructions to implement the specified logical function(s). The program instructions can be embodied in the form of source code stored and accessible from memory that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagram flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some examples, one or more of the blocks shown in the drawings can be skipped or omitted.

The Transfer-GAN framework, which can comprise an ordered listing of executable program instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. Any logic or application described herein that includes software or code can be embodied in any non-transitory computer-readable medium for use by or in connection with an instruction execution system such as, for example, a processor in a computer system or other system. In this sense, the logic can include, for example, statements including program instructions, program code, and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for multimodal computed tomography (CT) image super-resolution, comprising:
generating an enhanced super-resolution generative adversarial network (ESRGAN) by training a generative adversarial network (GAN) with a plurality of CT image modalities; and
generating an enhanced CT image by applying the ESRGAN to a low resolution CT image.

2. The method of claim 1, wherein the training of the GAN comprises:
training the GAN with a first CT image modality; and
training the GAN with a second CT image modality, wherein the GAN includes learning from the training with the first CT image modality.

3. The method of claim 2, wherein the first CT image modality is non-contrast CT (NCCT) and the second CT image modality is CT Perfusion (CTP).

4. The method of claim 2, wherein the training of the GAN further comprises training the GAN with a third CT image modality, wherein the GAN includes learning from the training with the first and second CT image modalities.

5. The method of claim 4, wherein the third CT image modality is CT Angiography (CTA).

6. The method of claim 1, wherein the plurality of CT image modalities are selected from the group consisting of non-contrast CT (NCCT), CT Perfusion (CTP), CT Angiography (CTA), and CT with contrast-enhanced (CTWC).

7. The method of claim 1, wherein the ESRGAN comprises a plurality of residual in residual dense blocks (RRDBs) in series.

8. The method of claim 7, wherein each of the plurality of RRDBs comprise a convolution (Cony) layer and a leaky rectified linear unit (LReLU).

9. The method of claim 1, wherein the low resolution CT image is obtained from a low dose CT scan.

10. A system for multimodal computed tomography (CT) image super-resolution, comprising:
at least one computing device; and
program instructions stored in memory and executable in the at least one computing device that, when executed, cause the at least one computing device to:
generate an enhanced super-resolution generative adversarial network (ESRGAN) by training a generative adversarial network (GAN) with a plurality of CT image modalities; and
generate an enhanced CT image by applying the ESRGAN to a low resolution CT image.

11. The system of claim 10, wherein the training of the GAN comprises:
training the GAN with a first CT image modality; and
training the GAN with a second CT image modality, wherein the GAN includes learning from the training with the first CT image modality.

12. The system of claim 11, wherein the first CT image modality is non-contrast CT (NCCT) and the second CT image modality is CT Perfusion (CTP).

13. The system of claim 11, wherein the training of the GAN further comprises training the GAN with a third CT image modality, wherein the GAN includes learning from the training with the first and second CT image modalities.

14. The system of claim 13, wherein the third CT image modality is CT Angiography (CTA).

15. The system of claim 13, wherein the training of the GAN further comprises training the GAN with a fourth CT image modality, wherein the GAN includes learning from the training with the first, second and third CT image modalities.

16. The system of claim 15, wherein the first, second, third and fourth CT image modalities comprise non-contrast CT (NCCT), CT Perfusion (CTP), CT Angiography (CTA), and CT with contrast-enhanced (CTWC).

17. The system of claim 10, wherein the plurality of CT image modalities are selected from the group consisting of non-contrast CT (NCCT), CT Perfusion (CTP), CT Angiography (CTA), and CT with contrast-enhanced (CTWC).

18. The system of claim 10, wherein the ESRGAN comprises a plurality of residual in residual dense blocks (RRDBs) in series.

19. The system of claim 18, wherein each of the plurality of RRDBs comprise a convolution (Cony) layer and a leaky rectified linear unit (LReLU).

20. The system of claim 10, wherein the low resolution CT image is obtained from a low dose CT scan.
